(19) United States
(12) Patent Application Publication
(10) Pub. No.: US 2026/0290985 A1
(43) Pub. Date: Sep. 24, 2026

(54) BATTERY MODULE WITH POLYORGANOSILOXANE FOAM BARRIER

(71) Applicants: Dow Silicones Corporation, Midland, MI (US); Dow Global Technologies LLC, Midland, MI (US)

(72) Inventors: Chi-Hao Chang, Midland, MI (US); Craig F. Gorin, Midland, MI (US); Bizhong Zhu, Midland, MI (US); Michael Whitbrodt, Bay City, MI (US); Xiangyang Tai, Shanghai (CN); Minbiao Hu, Shanghai (CN); Xuesi Yao

(21) Appl. No.: 18/874,260

(22) PCT Filed: Jun. 27, 2022
(86) PCT No.: PCT/CN2022/101659

§ 371 Date: Dec. 12, 2024

(51) Int. Cl. H01M 50/293; H01M 10/643; H01M 10/658; H01M 50/213; H01M 50/24

(52) U.S. Cl. CPC H01M 50/293; H01M 10/643; H01M 10/658; H01M 50/213; H01M 50/24

(57) ABSTRACT

Disclosed is a battery module, comprising an array of spatially separated battery cells and a barrier material contacting adjacent battery cells. The barrier material, which comprises a polyorganosiloxane foam, a fire retardant, and expanded perlite, provides flame-resistance, compressibility and thermal insulation.

### BACKGROUND OF THE INVENTION

The present invention relates to a battery module insulated with a treated polyorganosiloxane foam barrier.

Rechargeable batteries such as lithium-ion batteries (LiBs) are commonly used in a variety of applications including electric vehicles (EVs) and grid energy storage systems. Although LiBs have the desirable properties of high energy density and stability, safety concerns currently limit their usefulness. First, failure of an LiB cell can be triggered due to a manufacturing defect, an internal short circuit, overheating, overcharging, or mechanical impact; second, the heat generated from the failing cell may propagate, thereby causing a thermal runaway in adjacent cells. The rapid pressure build-up arising from these thermal events increases the risks of fire and explosion.

Thermal runaway can be mitigated by placing a thermal barrier between cells in an LiB module, which provides heat insulation and flame resistance. Commonly used thermal barriers such as aerogel, ceramic fiber, and mica board provide such properties; however, aerogel and ceramic fiber suffer poor mechanical resilience, while mica board suffers from poor compressibility. On the other hand, although silicone blown foam provides adequate compressibility and, therefore, suitable for batteries of low and moderate energy density, it suffers from insufficient heat insulation to prevent thermal runaway for the very high energy density battery packs. Accordingly, it would be desirable in the field of thermal barriers for rechargeable batteries to create a barrier that provides heat insulation, flame resistance, and satisfactory compressibility.

### SUMMARY OF THE INVENTION

The present invention addresses a need in the art by providing a battery module comprising a shell containing an array of spatially separated battery cells and a barrier material contacting adjacent battery cells, wherein the barrier material comprises, based on the weight of the barrier material, from 35 to 95 weight percent of a polyorganosiloxane foam; from 1 to 30 weight percent of a fire retardant; and from 1 to 15 weight percent of expanded perlite; wherein the barrier material has a density in the range of from 0.10 to 0.90 g/cm³.

The battery module of the present invention provides improved thermal and flame-resistant properties for applications such as lithium-ion batteries.

### BRIEF DESCRIPTION OF DRAWINGS

FIG. 1 is an illustration of a battery module containing polyorganosiloxane foam material.

### DETAILED DESCRIPTION OF THE INVENTION

The present invention is a battery module comprising a shell containing an array of spatially separated battery cells and a barrier material contacting adjacent battery cells, wherein the barrier material comprises, based on the weight of the barrier material, from 35 to 95 weight percent of a polyorganosiloxane foam; from 1 to 30 weight percent of a fire retardant, and from 1 to 15 weight percent of expanded perlite; wherein the barrier material has a density in the range of from 0.10 to 0.90 g/cm³.

The barrier material, which is a heating-insulating, flame-resistant, and compressible foamed polyorganosiloxane, can be prepared by modification of a method described in U.S. Pat. No. 5,358,975. For example, a polydimethylsiloxane functionalized with at least two, and preferably at least three Si—H groups (a) is advantageously contacted with one or more hydroxyl containing compounds which is water, an alcohol, diol, polyol, or a compound containing at least one silanol group (b), a divinyl-functionalized polydimethylsiloxane (c), a hydrosilylation catalyst such as a platinum-based catalyst (d), a fire retardant (e), and expanded perlite (f) to form a crosslinked network of an insulating, compressible, and flame-resistant foamed material with —Si—CH₂—CH₂—Si— groups and —Si—O—R groups, where R is H or a the structural unit (i.e., the reaction product) of the alcohol, the diol, the polyol, or the silanol. The total of components (a), (b), and (c) range from 35 or from 40 weight percent, to 80 or to 70 weight percent of the polyorganosiloxane foam.

It may be advantageous to prepare the barrier material using a 2-part approach wherein in a first vessel a first portion of the divinyl-functionalized polydimethylsiloxane; a first portion of the fire retardant; the hydrosilylation catalyst; the hydroxyl containing compound or compounds; and a first portion of the expanded perlite are blended to form a Part A composition. In a second vessel, the remaining portion of the divinyl-functionalized polydimethylsiloxane; a polymer resin blend, which is a mixture of a divinyl-functionalized polydimethylsiloxane and a crosslinked organopolysiloxane resin; the remaining portion of the fire retardant; the polydimethylsiloxane functionalized with at least three Si—H groups; and the remaining portion of the expanded perlite are blended to form a Part B composition. Parts A and B are then combined and mixed, then poured between two release film sheets to form the foamed material of the present invention.

The fire retardant is a metal hydroxide, carbonate, hydroxide-carbonate, or hydrate that, upon heating, releases CO₂ or water or both. Examples of fire retardants include Al(OH)₃, Mg(OH)₂, Ca(OH)₂MgCO₃·3H₂O (nesquehonite), Mg₅(CO₃)₄(OH)₂·4H₂O (hydromagnesite), MgCa(CO₃)₂ (huntite), AlO(OH)(boemite), NaHCO₃, and hydrated MgSO₄ (epsomite). The polyorganosiloxane foamed material comprises from 1 or from 2 or from 3 weight percent, to 30 or to 20 or to 15 weight percent of the fire retardant, based on the weight of the foamed material.

The barrier material further comprises from 1 or from 2 weight percent to 15 or to 10 weight percent of expanded perlite. Expanded perlite may be formed by heating perlite ore rapidly to a temperature in the range of from 750° C. to 1000° C. The resulting expanded particles generally have a dry bulk density in the range of from 0.03 to 0.20 g/cm³. The mean volume particle size is typically in the range of from 0.1 μm to 1000 μm using a dynamic light scattering analyzer such as a Beckman Coulter LS 130 Particle Size Analyzer.

The resultant barrier material has a density in the range of from 0.10 g/cm³ or from 0.15 g/cm³, to 0.90 g/cm³ or to 0.50 g/cm³.

In another aspect, the present invention is a composition comprising, based on the weight of the composition, a) from 2 to 50 weight percent of a polysiloxane functionalized with at least two Si—H groups and having a degree of polymerization in the range of from 5 to 1000; b) from 1 to weight 50 percent of water, an alcohol, a diol, a polyol, or a compound containing one or more silanol groups; c) from 10 to 90 weight percent of a polysiloxane functionalized with at least one ethylenically unsaturated group and having a degree of polymerization in the range of from 20 to 2000; wherein the total concentration of components a, b, and c is in the range of from 35 to 95 weight percent, based on the weight of the composition; d) a catalytic amount of a hydrosilylation catalyst; e) from 1 to 30 weight percent of a fire retardant; and f) from 1 to 35 weight percent of expanded perlite.

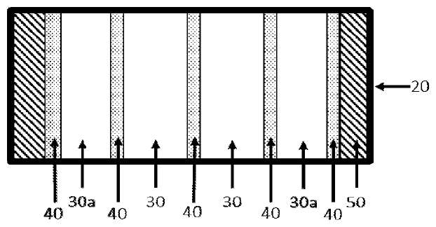

FIG. 1 represents an embodiment of the present invention. A battery module comprises a shell (20) housing an array of spatially separated battery cells (30 and 30a) and barrier material (40) contacting adjacent battery cells, thereby creating an insulating barrier between battery cells (30). In this embodiment, the barrier material is positioned between adjacent battery cells (30); in another embodiment, the barrier material covers the battery cells. The battery module may further comprise end plates (50) at the internal edges of the shell that are in direct contact with battery cells (not shown) or indirect contact with battery cells through the barrier foam (30a). The barrier material can be inserted into the spaces between adjacent battery cells and between the cells and end plates; alternatively, a foam precursor can be applied onto the cells and into the spaces between battery cells, then cured to form the barrier material.

Examples of suitable battery cell designs include cylindrical, pouch, and prismatic cells. A particularly advantageous module comprises pouch or prismatic cells with pre-fabricated barrier material in the form of foam sheets positioned between cells during assembly. For a cylindrical design, a pre-cursor foam material is typically dispensed into the spaces separating the cylindrical cells, then cured to form barrier material surrounding the cylindrical cells.

The battery module with the barrier material as described herein has been found to provide the desired properties of beat insulation, flame-resistance, and compressibility in rechargeable battery thermal barrier applications.

In the following examples, M_{w} and Mₙ of the ViMe₂SiO_{1/2}(CH₃)₃Si—O_{1/2}/SiO_{4/2} resin was determined by gel permeation chromatography (gpc) using a gpc column packed with 5-mm diameter sized divinyl benzene crosslinked polystyrene beads pore type Mixed-C (Polymer Laboratory). Tetrahydrofuran was used as the mobile phase and detection was carried out by a refractive index detector.

In the following examples, M_{w} and Mₙ of the ViMe₂SiO_{1/2}/(CH₃)₃Si—O_{1/2}/SiO_{4/2} resin was determined by gel permeation chromatography using a gpc column packed with 5-mm diameter sized divinyl benzene crosslinked polystyrene beads pore type Mixed-C (Polymer Laboratory). THF was used as the mobile phase and detection was carried out by a refractive index detector.

### Example 1—Preparation of Foamed Organopolysiloxane Article with Expanded Perlite Particles

A first component (Part A) was prepared by mixing together, using a Flacktek Speed Mixer, a dimethylvinylsiloxy end-capped polydimethylsiloxane having a viscosity of −40,000 mPas (Polymer 1, 11.0 pbw), a 64:36 w/w blend of 1) a dimethylvinylsiloxy-terminated polydimethylsiloxane, having a viscosity of ~1,900 mPa·s, and ~0.22 wt. % of Vi; and 2) a ViMe₂SiO_{1/2}/(CH₃)₃Si—O_{1/2}/SiO_{4/2} resin, having a ViMe₂SiO_{1/2}:(CH₃)₃Si—O_{1/2}:SiO_{4/2} structural unit ratio of 5:40:55, a Mₙ of 5000 and a M_{w} of 21,400 (Polymer-Resin Blend, 62.9 pbw); and Micral 855 aluminum hydroxide (14.7 pbw). The contents were stirred at 2000 rpm for 30 s, after which time, a complex of Pt(0) and divinyltetramethyldisiloxane (0.9 pbw, 0.62 wt % Pt), 1,4-butanediol (2.5 pbw), and benzyl alcohol (3.2 pbw) were added to the mixture and the contents were stirred at 2000 rpm for 30 s. Finally, Omyasphere TP-312 FQ expanded perlite particles (mean volume average particle size of 63 μm; 4.8 pbw) were added to the mixture and the contents were stirred at 2000 rpm for 30 s.

A second composition (Part B) was similarly prepared by mixing together Polymer 1 (8.6 pbw), Polymer Resin Blend (49.5 pbw), and Hymod M855 aluminum hydroxide (25.6 pbw). The contents were stirred at 2000 rpm for 30 s, after which time a linear organohydrogenpolysiloxane having a viscosity of 30 mPa·s and 1.6 wt % SiH content (6.5 pbw), and a polydimethylorganohydrogensiloxane with viscosity of 5 mPa·s and 0.7 wt % SiH content (4.9 pbw) were added to the mixture and the contents were stirred at 2000 rpm for 30 s. Then, Omyasphere TP-312 FQ expanded perlite particles (mean volume average particle size of 63 μm, 4.8 pbw) were added to the mixture and the contents were stirred at 2000 rpm for 30 s.

Equal amounts of Parts A and B were then mixed, and the mixture was poured between two release film sheets (matte mylar film). The initial (before foaming) thickness was controlled at 0.045 inch using a nip roller. The sample was cured at 70° C. for 5 min, then 100° C. for 15 min, producing a foam sheet that was used for further testing. (Density=0.29 g/cm³)

### Example 2—Preparation of Foamed Organopolysiloxane Article with Expanded Perlite Particles

The process for preparing the foamed article of Example 1 was carried out in substantially the same way except that Omyasphere 235 T-FQ expanded perlite particles (mean volume average particle size of 124 μm, 4.8 pbw) were used in Parts A and B. (Density=0.31 g/cm³).

### Example 3—Preparation of Foamed Organopolysiloxane Article with Expanded Perlite Particles

The process for preparing the foamed article of Example 1 was carried out in substantially the same way except that Omyasphere 235 T-FQ expanded perlite particles (9.1 pbw) were used in Parts A and B. (Density=0.35 g/cm³)

### Comparative Example 2—Preparation of Foamed Organopolysiloxane Article with Hollow Glass Beads

The process for preparing the foamed article of Example 1 was carried out in substantially the same way except that 3M iM16K hollow glass beads (mean volume average particle size of 20 μm, 20 pbw) were used in Parts A and B. (Density=0.28 g/cm³). The amount of beads were selected to give a similar filler volume as the expanded perlite in Example 1.

### Thermal Insulation and Flammability

The foams prepared as described in the examples were tested for thermal insulation and flammability using a hot plate set onto a hydraulic press. The hot plate was set at 600° C. with an insulator on the top of surface. Four thermocouples (K-type) were fixed onto an aluminum heat sink (4″×4″×0.47″) using Kapton tape. A sample (4″×4″) was then placed and fixed onto the heat sink using Kapton tape. An additional thermocouple (K-type) was attached to the sample surface using Kapton tape. The insulator was removed from the hot surface and the sample attached to the heat sink was rapidly placed onto the hot surface with the sample surface facing the hot plate surface, and the Al heat sink facing the opposite side. The pressure was quickly increased to 355 kPa. The interfacial temperature between the hot plate surface and the sample surface, and the interfacial temperature between the sample surface and the heat sink were recorded using a data logger. Once the time reached 300 s, the pressure was released, and the test was ended. A temperature at the sample surface of <300° C. was considered acceptable. No observable flame throughout the test is considered acceptable flame resistance.

### Hardness

Hardness was measured using a Shore 00 durometer. A test specimen was placed on a hard flat surface. The indenter of Shore 00 durometer was then pressed onto the specimen making sure that it was parallel to the surface. The hardness was read during firm contact with the specimen. A hardness of <80 was considered acceptable.

### Compression Force

Compression force was measured using a TA.HDplus texture analyzer equipped with a 100 kg load cell, an aluminum probe with a diameter of 40 mm, and a flat heavy-duty aluminum substrate. A silicone foam sample was cut in a circle using a die cut with a diameter of 1″ and placed between the substrate and the probe. The probe was initially set at the same height as the sample thickness, and lowered at the rate of 1 mm/s until the pressure maxed out. The sample thickness and pressure were recorded as a compression force curve. The pressures at 30% of original sample thickness were recorded. A compression force of <500 kPa was considered acceptable.

### Foam Density

Foam density was calculated based on the average thickness and weight of two foam samples with a diameter of 1 inch.

The properties of the expanded perlite filled organopolysiloxane article were compared to two other foams: Comparative Example 1, which is a commercial organopolysiloxane article (COHRlastic Silicone Foam, available from Stockwell Elastomerics), which was similar in construction to the example foams except it did not contain expanded perlite; and Comparative Example 2, which is a foam containing 3M Glass Bubbles iM16K Hollow Glass Microspheres.

Table 1 is a summary of performance properties for the foams of the Examples 1-3 the commercial comparative foam, and the foam containing hollow glass microspheres. Density was measured in g/cm³; Hardness was measured in Shore 00 units; Compressive Force (Force) was measured in kPa@30% compression; Temperature at 600° C. (T after 300 s) refers to the sample surface temperature after 300 s; and Flammability refers to observability of a flame during the thermal insulation test.

TP-312-FQ refers to Omyasphere TP-312-FQ Expanded Perlite; 235T-FQ refers Omyasphere 235-T-FQ Expanded Perlite; and iM16K refers to 3M Glass Bubbles iM16K Hollow Glass Microspheres.

TABLE 1
Properties of Organopolysiloxane Article

| Property | Criteria | Comp. 1 | Example 1 | Example 2 | Example 3 | Comp. 2 |
|---|---|---|---|---|---|---|
| Filler | | none | TP-312-FQ | 235 T-FQ | 235 T-FQ | iM16K |
| Density | <0.9 | 0.23 | 0.289 | 0.307 | 0.354 | 0.282 |
| Hardness | <80 | 35 | 61 | 65 | 75 | 82 |
| Force | <500 | 17 | 158 | 202 | 424 | 791 |
| T after 300 s | <300° C. | 334 | 266 | 255 | 251 | 266 |
| Flammability | No Flame | No Flame | No Flame | No Flame | No Flame | No Flame |

Table 1 illustrates that the expanded perlite containing foams of the present invention pass all tests, while the sample without expanded perlite (Comparative Example 1) fails the test for thermal insulation test, and the sample with hollow glass microsphere filler (Comparative Example 2) fails the test for compression force.

1. A battery module comprising a shell containing an array of spatially separated battery cells and a barrier material contacting adjacent battery cells, wherein the barrier material comprises, based on the weight of the barrier material, from 35 to 95 weight percent of a polyorganosiloxane foam; from 1 to 30 weight percent of a fire retardant; and from 1 to 15 weight percent of expanded perlite; wherein the barrier material has a density in the range of from 0.10 to 0.90 g/cm³.

2. The battery module of claim 1 wherein the barrier material comprises, based on the weight of the barrier material, from 50 to 80 weight percent of the polyorganosiloxane foam, from 2 to 20 weight percent of the fire retardant, and from 2 to 10 weight percent expanded perlite.

3. The battery module of claim 2 wherein the fire retardant is Al(OH)₃, Mg(OH)₂, MgCO₃·3H₂O, or Mg₅(CO₃)₄(OH)₂·4H₂O, MgCa(CO₃)₂, AlO(OH), NaHCO₃, or hydrated MgSO₄, or a combination thereof.

4. The battery module of claim 1 wherein the barrier material has a density in the range of from 0.15 to 0.50 g/cm³.

5. The battery module of claim 1 which comprises pouch or prismatic battery cells and sheets of the barrier material positioned between adjacent battery cells.

6. The battery module of claim 1 which comprises cylindrical battery cells with the barrier material surrounding the cylindrical battery cells.
